(19) United States
(12) Patent Application Publication
(10) Pub. No.: US 2009/0021225 A1
(43) Pub. Date: Jan. 22, 2009

(54) DEVICE FOR SUPPLYING THE INDUCTOR OF A ROTATING ELECTRICAL MACHINE

(76) Inventors: Jean-Marie Pierret, Paris (FR); Raymond Rechdan, Saint-Maurice (FR)

Correspondence Address: BERENATO, WHITE & STAVISH, LLC, 6550 ROCK SPRING DRIVE, SUITE 240, BETHESDA, MD, 20817, US

(21) Appl. No.: 12/159,277

(22) PCT Filed: Jan. 9, 2007
(86) PCT No.: PCT/FR2007/050629

§ 371 Date: Jun. 26, 2008

(30) Foreign Application Priority Data
Jan. 12, 2006 (FR) 0600275

(51) Int. Cl. H02P 9/14

(52) U.S. Cl. 322/86

(57) ABSTRACT

Device for supplying the inductor (3) of a rotating electrical machine, the device comprising a circuit (21) for supplying the inductor in nominal mode. The device also includes a circuit (22) for supplying the inductor (3) in auxiliary mode and a mode selector (23) capable, on the one hand, of comparing the output voltage (Ualt) delivered by the machine with a threshold voltage at least equal to the minimum voltage for operating the nominal supply circuit (21) and, on the other hand, of selecting the auxiliary supply mode if the output voltage (Ualt) is below the threshold voltage. Application to motor vehicle load circuits.

The present invention concerns a device for supplying the field winding of a rotary electrical machine.

The invention finds an advantageous application in the field of the automotive industry, and more particularly in that of motor vehicle charging circuits, the rotary electrical machine in question then consisting of the alternator of the vehicle or an alternator starter in its alternator mode.

In this context, the invention concerns the functioning in degraded mode of the charging circuit of motor vehicles, for the purpose of preventing the de-energising of the machine when the battery is disconnected from the onboard system. This de-energising is generally caused by powering up a high load giving rise to a collapse of the voltage of the onboard system, which is then no longer maintained by the battery.

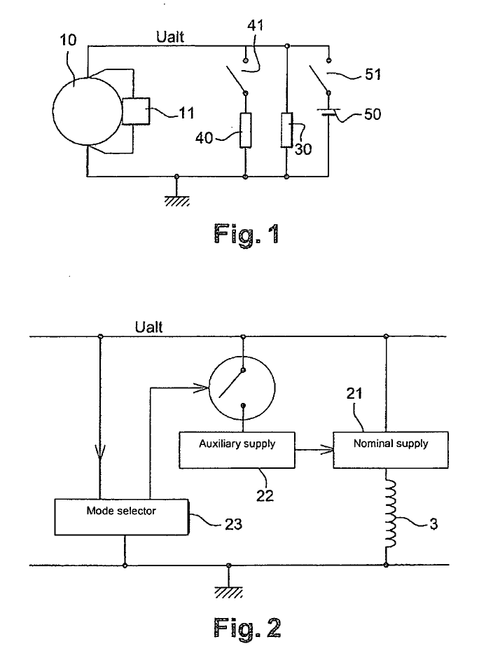

FIG. 1 depicts a general diagram of an onboard system of a vehicle.

This circuit consists of an alternator 10 comprising a voltage regulator 11, a battery 50, permanent loads 30 and loads 40 switchable or pulsed on the onboard system via the switch 41. The electrical connections between the alternator, the battery and the loads are taken firstly to the potential of the onboard system Ualt and secondly to the earth potential. The switch 51 represents a lack of connection between the battery 50 and the rest of the onboard system.

In normal functioning, the battery 50 is connected to the rest of the system, the switch 51 being closed. The battery 50 stabilises, filters and maintains the voltage of the system in the case of a variation in load. No de-energisation of the alternator is possible since there is always an excitation current in the rotor.

In the event of disconnection of the battery, the switch 51 is open and the application of an additional load, represented by the closure of the switch 41, makes the voltage of the onboard system drop because the alternator cannot immediately compensate for the demand for charging because of an excessively slow response time.

Current battery voltage regulators do not have means especially designed to prevent the de-energisation of the alternator in the absence of the voltage delivered by the battery, the latter being disconnected or out of service. In fact, the alternator de-energises rapidly, which causes the onboard system to be de-energised.

The de-energisation of the alternator is caused by the absence of an excitation current in the rotor. De-energisation is also caused when the excitation current has an excessively low value compared with the load on the network.

A first improvement consists of effecting a so-called priority regulation that gives rise to a “full field” state, that is to say without chopping the excitation, when the voltage output from the alternator becomes less than a certain value, 9.75 volts for example for a 12 volt battery.

Priority regulation eliminates all related functions, such as timing and progressive charging, liable to prevent the rapid increase in the excitation current when there is a high demand for charging.

However, the impedance of the field winding limits the rapid increase in the excitation current and a demand for charging may take the voltage of the onboard system below the minimum operating level of the regulator.

In addition, current regulators often comprise an output stage consisting of an MOS transistor connected to the positive potential, in a so-called “high side” circuit, the said transistor being controlled by a charge pump requiring a sufficient supply voltage to be able to function. This charge pump, and the control circuits of the regulator, such as the clock and the logic circuits, are no longer active for low supply voltages resulting from a demand for charging when the battery is out of service. Under these conditions, the output stage of the regulator is open and the field winding is no longer supplied by its nominal supply circuit, which causes the de-energisation of the alternator.

Conventional priority regulation is therefore not a sufficient means for preventing the de-energisation of the alternator when the battery is disconnected. A second improvement consists of integrating an asynchronous excitation function with respect to the regulation loop when the voltage Ualt reaches a threshold close to 9 volts for example, in order to limit the rapid fall in voltage and therefore prevent a de-energisation.

This excitation function does however have its limits since, as from a certain current and despite the presence of an excitation, the voltage continues to fall to a very low level where the logic circuits of the nominal circuit supplying the field winding are no longer supplied, which completely interrupts excitation and causes de-energisation.

However, the drop in voltage of the onboard system causes the de-energisation of the vehicle engine, the switching off of the lights and the de-energisation of certain circuits that may have a safety aspect, such as the braking circuit and the electrical assisted steering. These circuits being more and more numerous in vehicles, it appears necessary to reduce the detrimental effects caused by de-energisation of the alternator arising following a break in the battery connection. Through the patent application GB 1 560 298 A, a circuit supplying the rotor of an alternator is known that makes it possible to supply a charging current and an auto-excitation current to the rotor. The supply circuit comprises a voltage doubler connected to the phase outputs of the alternator, this voltage doubler being supplied continuously during the functioning of the vehicle.

The U.S. Pat. No. 4,695,786 describes a voltage regulator functioning in nominal mode and comprising an activation stage consisting of two Dadington transistors. The regulator also comprises an intermediate stage which, when the alternator is started, creates a slight drop in voltage in the activation stage. The rotor thus has available a current of sufficient intensity to provide the starting of the alternator.

The technical problem to be resolved by the object of the present invention is to propose a device for supplying the field winding of a rotary electrical machine, the said device comprising a circuit supplying the said field winding in nominal mode, which would prevent a de-energisation of the supply to the field winding in the case where a high charging demand occurs while the battery, or any other storage member, is no longer in a position to deliver voltage on the onboard system.

The solution to the technical problem posed consists, according to the present invention, of the said device also comprising a circuit supplying the field winding in auxiliary mode and a mode selector able firstly to compare the output voltage delivered by the machine with a threshold voltage at least equal to the minimum operating voltage of the said nominal supply circuit, and secondly to select the said auxiliary supply if the said output voltage is less than the said threshold voltage.

Thus when, following the battery being put out of commission, the voltage Ualt delivered by the machine becomes less for example than a threshold voltage of around 6 V, the auxiliary mode supply circuit is acted on by the mode selector in order to ensure that an excitation current is maintained in the rotor of the alternator in order not to de-energise it.

Advantageously, the auxiliary mode supply circuit is selected only when the output voltage delivered by the machine is below the threshold voltage.

According to a first embodiment, the said auxiliary supply circuit comprises a charge pump circuit supplied by at least one phase of the machine armature and able to maintain the conduction of an excitation element of the field winding.

As will be seen in detail below, this embodiment takes account of the presence, on the phases of the armature of the machine, of a residual voltage related to a remanent magnet field on the poles of the field winding.

Advantageously, in order to maintain conduction in the nominal supply circuit, even at very low voltages Ualt, the said auxiliary supply circuit also comprises a circuit for putting the said excitation element in conduction as a priority.

The said excitation element is in particular an NMOS transistor.

According to a second embodiment, an auxiliary charge pump is not used but the said auxiliary supply circuit comprises an auxiliary excitation element for the said field winding disposed in parallel to a nominal excitation element of the field winding.

In this case, the invention also makes provision for, the said nominal excitation element being an NMOS transistor, the auxiliary excitation element to be a PMOS transistor.

It is even possible to envisage, in this second embodiment, for the said auxiliary excitation element and the said nominal excitation element to constitute a single excitation element.

The description that follows with regard to the accompanying drawings, given by way of non-limitative examples, will give a clear understanding of what the invention consists and how it can be implemented.

FIG. 2 is a general diagram of a supply device according to the invention.

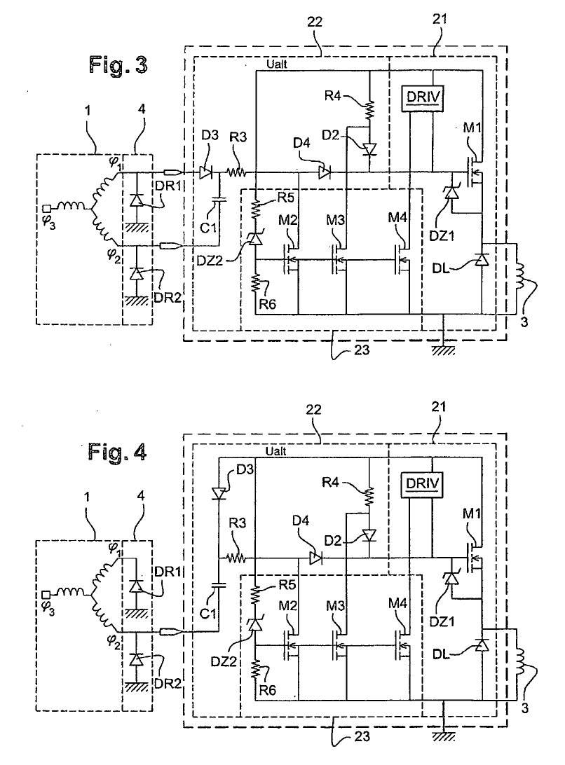

FIG. 3 is a diagram of a first embodiment of the device of FIG. 2.

FIG. 4 is a diagram of a variant of the device of FIG. 3.

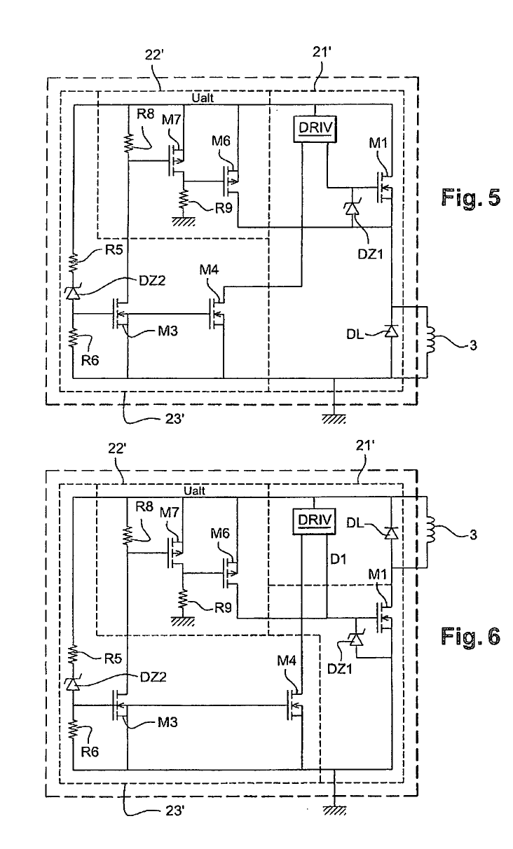

FIG. 5 is a diagram of a second embodiment of the device of FIG. 2.

FIG. 6 is a diagram of a first variant of the device of FIG. 5.

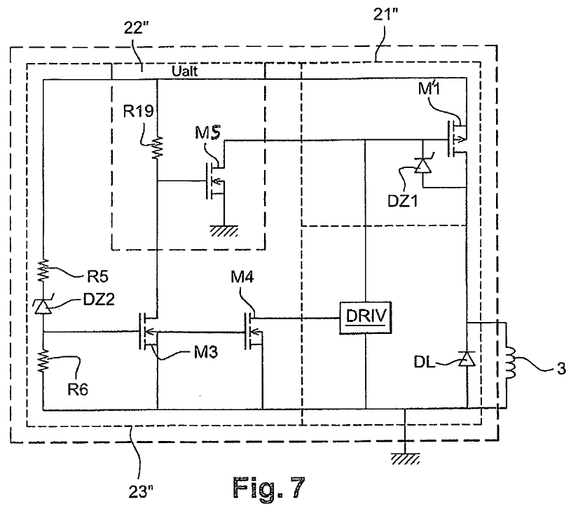

FIG. 7 is a diagram of a second variant of the device of FIG. 5.

FIG. 2 depicts a diagram of a supply device for the field winding 3 of a rotary electrical machine, such as the alternator or alternator starter of a motor vehicle. This device comprises a circuit 21 for supplying the field winding 3 in nominal mode comprising in particular an excitation element for the said field winding, consisting for example of a power NMOS transistor. A more detailed description of this nominal mode supply circuit 21 will be provided later with regard to FIG. 3.

The supply device of FIG. 2 also indicates the presence of a circuit 22 for supplying the field winding 3 in auxiliary mode, intended to prevent the de-energisation of the said field winding when the battery, or any other electrical energy storage element, is no longer in a position to supply the onboard system of the vehicle, in particular in the case of disconnection.

The passage from nominal supply mode to auxiliary mode is decided on by a mode selector 23 able to compare the output voltage Ualt delivered by the machine on the network with a threshold voltage Uthreshold at least equal to the minimum operating voltage of the said nominal supply circuit 21. This operating voltage is in general that of the logic components of the circuit 21, namely 5 V for example. In this case, the threshold voltage Uthreshold can be taken to be equal to approximately 6 V and more generally between 5 and 7 V, so as to be free of the fluctuations in the voltage Ualt, which may be high because of the absence of filtering performed by the battery because of its disconnection.

If the output voltage Ualt of the machine is less than the threshold voltage Uthreshold, the mode selector 23 then uses the supply circuit 22 in auxiliary mode.

FIG. 3 gives a diagram of a first embodiment of the device of FIG. 2.

In general terms, this embodiment is based on the use of residual signals on the phases φ1, φ2 at the output of the armature 1 of the machine in order to supply the field winding 3 via the NMOS excitation transistor M1.

This because, when the alternator, or alternator stator, is rotating, these signals are always present, even in the absence of an inducing current. They are in fact by the remanence of the magnetic circuit of the field winding 3. The amplitude of these signals is proportional to the speed of rotation and depends on the state of the magnetic circuit of the alternator. In particular, it is higher if the steel of the field winding 3 contains a high level of carbon or if it comprises interpole magnets promoting the remanence of the magnetic circuit.

At high rotation speeds, the electromotive force delivered on the phases φ1 and φ2 is sufficient to re-energise the alternator, even if the voltage at its terminals is zero.

On the other hand, at low rotation speeds, this electromotive force is insufficient to re-energise the alternator. Despite the application of a high charge, a residual voltage must be able to be preserved on the system in order to be able to re-energise the field winding 3, around 2 volts at 4000 revolutions per minute.

The electromotive force on the phases φ1 and φ2 can be applied directly to the field winding 3 without passing through the excitation transistor M1. For this purpose, a bridge rectifier 4 is used that is deactivated when the voltage is sufficient to re-energise the alternator. The bridge rectifier 4 is implemented by the diodes DR1 and DR2 connected to earth and to the outputs of the phases φ1 and φ2 respectively. The other diodes of the bridge rectifier are not shown since they do not have any functional characteristic relating to the invention.

The efficacy of the bridge rectifier 4 can be increased by replacing the diodes of the bridge with synchronous-rectification transistors. However, controlling these transistors is difficult to achieve because of the very low voltage available to control them.

As shown in FIG. 3, it is preferred to indirectly apply the electromotive force on the phases φ1 and φ2 to the field winding 3 passing through the bridge rectifier 4 and excitation transistor M1. However, when a “high side” connected NMOS transistor is used, the very low voltage available on the alternator regulator does not allow the functioning of the charge pump that conventionally equips the normal supply circuits 21 and that makes it possible to keep the excitation transistor M1 completely closed.

This is why the device in FIG. 3, when the voltage Ualt of the system falls below a predetermined threshold Uthreshold, provides for the normal charge pump to be replaced by an auxiliary charge pump of a supply circuit 22 in auxiliary mode, actuated by the signals present on the phases φ1 and φ2. These signals can be made always available by means of a circuit for the priority putting in conduction of the excitation transistor M1, intended to preserve the magnetisation of the field winding 3.

The change from nominal to auxiliary mode is achieved by means of the mode selector 23.

The device of FIG. 3 will now be described in detail.

The armature 1 of the alternator consists of a winding comprising three phases φ1, φ2 and φ3. The bridge rectifier 4 is implemented by the diodes DR1 and DR2 connected to earth and to the outputs of the phases φ1 and φ2 respectively. The other diodes of the bridge rectifier are not shown since they do not have any functional characteristic relating to the invention.

The device supplying the field winding 3 comprises the following elements:

a nominal mode supply circuit 21 consisting of the NMOS excitation transistor M1 connected in “high side” configuration with respect to the field winding 3. A clipper diode DZ1 that protects the gate of this transistor, a diode DL, referred to as a freewheeling diode, and a control circuit DRIV ensure the functioning of the transistor M1 in nominal mode. This control circuit DRIV receives the information from the weak-signal circuits of the regulator (not shown). The power NMOS transistor M1 has a gate-source threshold voltage of low value, equal to 1.5 volts for example. This power stage has many other particularities that will not be described here since they form part of the prior art of battery voltage regulators,

an auxiliary mode supply circuit 22 comprising:

a charge pump consisting of the diodes D3 and D4, the resistor R3 and the capacitor C1. The diode D3 and the capacitor C1 are connected respectively to the outputs of the phases φ1 and φ2. The diode D4 is connected to the gate of the transistor M1. This charge pump circuit uses the voltage delivered on the outputs of the phases φ1, φ2 in order to apply a voltage higher than Ualt to the gate of the transistor M1. This charge pump 23, supplied by the phase potentials, is different from the charge pump supplied by the oscillator used in nominal regulation mode,

a circuit for priority putting in conduction of the NMOS transistor M1, consisting of a diode D2 and a resistor R4 connecting the gate of the transistor M1 to the voltage Ualt of the onboard system. This circuit enables the transistor M1 to be made conductive in linear mode when the voltage Ualt has dropped greatly,

the mode selector 23 consists of a threshold detector comprising a resistor bridge R5, R6 and a clipper diode DZ2. The clipper diode DZ2 controls the open or closed state of the transistors M2, M3 and M4. This mode selection circuit 23 allows the functioning of the auxiliary circuit 22 when the nominal mode circuits can no longer function because of an excessively low supply voltage Ualt. For example, the switching of the threshold detector can be provided for a supply voltage Ualt=Uthreshold of between 5 and 7V, for example 6V. In the embodiment proposed, the transistors M2, M3 and M4 are closed when Ualt>Uthreshold and open when Ualt<Uthreshold. This threshold detector can be implemented in many ways without departing from the invention provided that its functioning is ensured up to zero voltages (Ualt=0), such as a divider bridge, the midpoint of which is connected to the gates of the transistors M2, M3 and M4, a comparator the two inputs of which receive the potentials Ualt and Uthreshold respectively, transistors M2, M3 and M4 in MOS or bipolar technology, etc.

The device in FIG. 3 functions as follows.

In stabilised charging condition, the voltage Ualt at the output of the alternator is regulated in a conventional fashion. However, the voltage ripple level caused by the rectification is higher since the battery is no longer present to filter this ripple, which can cause a less precise regulation.

During a high charging demand on the occasion of an abrupt passage from a low load to a high load, the voltage Ualt drops greatly. However, the variation in excitation current is slowed down by the inductance level of the excitation winding. For a few milliseconds, it can be considered that the variation in the excitation current is negligible. Moreover, the reduction in the voltage Ualt reduces the current in the new load and increases the current delivered by the alternator. Consequently, an equilibrium occurs between the current delivered by the alternator and the current absorbed by the load for a voltage Ualt that remains much greater than earth potential despite a high drop. For example, this voltage Ualt can stabilise at a value of around 4 volts in an extreme case.

Under these conditions, the components of the circuit 21 of the nominal regulation mode can no longer be supplied and open the excitation transistor M1.

However, the elimination of any excitation current is avoided because the mode selector 23 detects the drop in the voltage Ualt between 5 and 7 volts for example. It makes it possible to pass from nominal supply mode to auxiliary mode because the divider bridge R5, R6, DZ2 no longer keeps the transistors M2, M3 and M4 closed. Under these circumstances, the circuit DRIV controlling the excitation transistor M1 is deactivated, the charge pump and the circuit for priority putting in conduction of the auxiliary circuit 22 are activated and can charge the gate of the transistor M1.

Initially, only the activation of the circuit for priority putting in conduction of figure is considered.

The current flowing in the resistor R4 is very low since it comes from the leakage current from the gate of the transistor M1. Consequently the voltage at the terminals of the resistor R4 is negligible.

Thus the voltage V_{DS} at the terminals of the transistor M1 is equal to the voltage V_{D2} at the terminals of the diode D2 plus the gate voltage V_{GS} of the transistor M1:

V_{DS}=V_{D2}+V_{GS}

If V_{GS}=1.5V and V_{D2}=0.7V, this gives:

V_{DS}=2.2V

The transistor M1 is conductive in linear mode. If the voltage Ualt drops for example to 4 volts, the field winding 3 remains supplied at a voltage of 1.8 volts.

This excitation voltage is sufficient to keep an electromotive force between the phases φ1 and φ2. If the direct voltage drop of the rectifying diodes is equal to V_{d}=0.7 V, the electromotive force between φ1 and φ2 is equal to:

V(φ1−φ2)=Ualt+2·V_{d}

V(φ1−φ2)=4+(2×0.7)=5.4 V

Secondly, this electromotive force level between φ1 and φ2 is used to ensure the functioning of the charge pump making it possible to charge the gate of the transistor M1 to a higher value than Ualt in order to completely close the transistor.

This is because:

during a half cycle of the signals on the phases φ1 and φ2, the capacitor C1 is charged at a voltage equal to:

V(C1)=V(φ1−φ2)−V(D3),

during the following half cycle, this charge is applied to the gate of the transistor M1 via the diode D4. The potential V_{G} of the gate of the transistor M1 with respect to earth is equal to:

V_{G}=V(C1)+V(φ1−φ2)−V(DR1)−V(D4)

let:

V_{G}=2·V(φ1−φ2)−V(D3)−V(DR1)−V(D4)

V_{G}=2·(Ualt+2·V_{d})−V(D3)−V(DR1)−V(D4)

If the voltage drop in the diodes DR1, DR2, D3 and D4 is equal to V_{d}, the potential of the gate of the transistor M1 with a respect to earth is equal to:

V_{G}=2·(Ualt=2·V_{D})−3·V_{d}

V_{G}=2·Ualt=V_{d}

V_{G}=8.7 V.

This voltage of 8.7 V between gate and earth is amply sufficient to completely close the transistor M1 for a voltage Ualt equal for example to 4 V.

The drain-source voltage is practically zero and the voltage V_{GS} between the gate and source of the transistor M1 is equal to:

V_{GS}=V_{G}−Ualt

V_{GS}=4.7 volts

Thus the signals on the phases φ1 and φ2 applied to the auxiliary charge pump make it possible to completely close the excitation transistor M1, even at very low supply voltages Ualt. As a first approximation, this auxiliary charge pump makes it possible to have available a gate-source voltage V_{GS} at least equal to the voltage Ualt output from the alternator provided that the gate of the transistor M1 sufficiently isolated to be capable of keeping the charges in the gate of the transistor M1 despite the very low frequency of the signals on the phases, 150 to 2000 Hz. For this purpose, the isolation resistances (not shown) must be greater than 100 megohms. Such isolation values are compatible with the semiconductor technologies used for battery voltage regulators.

In order not to de-energise, the minimum value of Ualt necessary decreases as the rotation speed of the alternator gets high. As from 7000 rev/min, the amplitude of the signals on the phases is sufficient to re-energise the alternator in the absence of this voltage Ualt.

All the means described above ensure that the field winding 3 remains supplied by the entire voltage Ualt, as well as the charges output from the alternator, even when Ualt decreases greatly following a call for charging. This condition prevents the de-energisation of the alternator.

According to the variant embodiment in FIG. 4, only the connection with the phase φ2 is kept. The diode D3 is then directly connected to the voltage Ualt. Compared with the previous embodiment with two phases, the charging of the capacitor C1 is lower by a junction V_{d}=0.7 V, which reduces the efficacy of the charge pump making it possible to charge the gate of the excitation transistor M1.

During one half cycle of the signals on the phases φ1 and φ2 the capacitor C1 is charged at a voltage equal to:

V(C1)=Ualt−V(D3)+V(DR2)=Ualt

During the following half cycle, this charge is applied to the gate of the transistor M1 via the diode D4. The potential V_{G} of the gate of the transistor M1 with respect to earth is equal to:

V_{G}=V(C1)+V(φ1−φ2)−V(DR1)−V(D4)

ie:

V_{G}=Ualt+(Ualt=2·V_{d})−V(DR1)−V(D4)

V_{G}=2·Ualt+2·V_{d}−V(DR1)−V(D4)

V_{G}=2·Ualt+2·V_{d}−2·V_{d}

V_{G}=2·Ualt

V_{G}=8 V

This voltage of 8 V between gate and earth is amply sufficient to completely close the transistor M1 for a voltage Ualt equal to 4 volts. The drain-source voltage is practically zero and the voltage V_{GS} between the gate and source of the transistor M1 is equal to:

V_{GS}=V_{G}−Ualt

V_{GS}=4 V

The gate voltage of the excitation transistor M1 is decreased by V_{d}, which reduces the performance at low rotation speeds compared with the solution using two phases, but this solution with a single phase remains acceptable for regulators having only a single phase input.

The diagram in FIG. 5 illustrates a second embodiment of the invention in which the auxiliary mode supply circuit 22′ comprises an auxiliary excitation element of the said field winding 3 disposed in parallel to the nominal excitation element of the field winding. In the example in FIG. 5, the said auxiliary excitation element is a PMOS transistor M6, the nominal excitation element being the NMOS transistor M1. Naturally the transistor M6 could also be a pnp bipolar transistor.

The auxiliary transistor M6 does not need a charge pump. When the voltage Ualt output from the alternator becomes less than the threshold voltage Uthreshold of between 5 and 7 volts, the transistor M6 is made conductive by the mode selector 23′ consisting of the components R5, DZ2, R6, M3, and by the transistor M7 and the resistors R8 and R9 of the auxiliary mode supply circuit 22′. It should be noted however that a PMOS transistor occupies a larger surface of silicon than a charge pump.

In the variant in FIG. 6, an NMOS transistor or an npn bipolar transistor is used as the excitation transistor M1, connected in “low side” configuration with respect to the field winding 6, with the risk however of causing corrosion on the coil of the field winding, which remains connected to the potential Ualt when the vehicle is at rest.

It is also possible to use only one transistor M′1 for the nominal and auxiliary excitation modes. This is what is shown by FIG. 7, where a PMOS transistor M′1 is connected in “high side” configuration with respect to the coil of the field winding 3. There also the difficulties related to the large surface of silicon occupied by the PMOS transistor are found again. In this FIG. 7 the auxiliary mode supply circuit 22′ is reduced to the transistor M5 and the resistor R19.

1. Device for supplying the field winding (3) of a rotary electrical machine, the said device comprising a circuit (21) for supplying the said field winding in nominal mode, characterised in that the said device also comprises a circuit (22) for supplying the field winding (3) in auxiliary mode and a mode selector (23) able firstly to compare the output voltage (Ualt) delivered by the machine with a threshold voltage (Uthreshold) at least equal to the minimum operating voltage of the said nominal supply circuit (21) and secondly to select the said auxiliary supply mode if the said output voltage (Ualt) is less than the said threshold voltage (Uthreshold).

2. Device according to claim 1, characterised in that the said auxiliary supply circuit (22) comprises a charge pump circuit supplied by at least one phase (φ1, φ2) of the armature (1) of the machine and able to maintain the conduction of an excitation element (M1) for the field winding (3).

3. Device according to claim 2, characterised in that the said auxiliary supply circuit (22) also comprises a circuit for the priority putting in conduction of the said excitation element (M1).

4. Device according to claim 2, characterised in that the said excitation element (M1) is an NMOS transistor.

5. Device according to claim 1, characterised in that the said auxiliary supply circuit (22′) comprises an auxiliary excitation element (M6) for the said field winding (3) disposed in parallel to a nominal excitation element (M1) for the field winding.

6. Device according to claim 5, characterised in that, the said nominal excitation element being an NMOS transistor (M1), the auxiliary excitation element is a PMOS transistor (M6).

7. Device according to claim 5, characterised in that the said auxiliary excitation element and the said nominal excitation element constitute a single excitation element (M′1).
